(19) United States
(12) Patent Application Publication
(10) Pub. No.: US 2011/0051815 A1
(43) Pub. Date: Mar. 3, 2011

(54) METHOD AND APPARATUS FOR ENCODING DATA AND METHOD AND APPARATUS FOR DECODING DATA

(75) Inventor: Yun-gu LEE, Seongnam-si, (KR)

(73) Assignee: SAMSUNG ELECTRONICS CO., LTD., Suwon-si (KR)

(21) Appl. No.: 12/823,602

(22) Filed: Jun. 25, 2010

(30) Foreign Application Priority Data
Aug. 25, 2009 (KR) 10-2009-0078845

(51) Int. Cl. H04N 7/12

(52) U.S. Cl. 375/240.24; 375/240.25; 375/E07.076; 375/E07.027

(57) ABSTRACT

An image data encoding and decoding method are provided, the encoding method including: compressing blocks of a first frame that is a reference frame, in units of a predetermined-sized block; determining whether each of the compressed blocks satisfies a respective target compression ratio; and selectively storing each of the compressed blocks based on the corresponding determination result for the respective compressed block.

### CROSS-REFERENCE TO RELATED PATENT APPLICATION

This application claims the benefit of Korean Patent Application No. 10-2009-0078845, filed on Aug. 25, 2009 in the Korean Intellectual Property Office, the disclosure of which is incorporated herein in its entirety by reference.

### BACKGROUND

1. Field

Exemplary embodiments relate to a method and apparatus for encoding and decoding data, and more particularly, to a method and apparatus for encoding and decoding image data.

2. Description of the Related Art

Recently, users are increasingly demanding high-quality audio/video (AV) data. In particular, as digital televisions (DTVs) become popular, the processing of high-quality and large-sized image data is regarded as a main issue.

Large-sized image data is encoded before being transmitted. In image encoding methods such as MPEG-1, MPEG-2, MPEG-4H.264/MPEG-4 advanced image coding (AVC) methods, each image frame is prediction-encoded by using inter prediction or intra prediction. Specifically, image frames of an image sequence are classified into intra (I), predictive (P) and bi-directional predictive (B) pictures and are prediction-encoded, thereby generating a bitstream of the image sequence.

### SUMMARY

According to an aspect of an exemplary embodiment, there is provided a method of encoding image data, the method including: compressing blocks of a first frame of the image data that is a reference frame; determining whether each of the compressed blocks satisfies a corresponding target compression ratio; and selectively storing each of the compressed blocks based on the determination results.

The selectively storing of the compressed blocks may include, if the compressed block is a compression block that satisfies a corresponding target compression ratio, storing the compressed block; and, if the compressed block is a skip block that does not satisfy a corresponding target compression ratio, not storing the compressed block.

The selectively storing of the compressed blocks may include, if the compressed block does not satisfy a corresponding target compression ratio, generating a skip flag representing that the compressed block is a skip block.

The method may further include performing a motion estimation on a second frame subsequent to the first frame by using the selectively stored blocks, and the performing of the motion estimation may include controlling the second frame not to refer to skip blocks.

The determining of whether each of the compressed blocks satisfies the corresponding target compression ratio may include determining a target compression ratio of a subsequent block to be subsequently compressed, based on a compression ratio of at least one previous block.

The determining of the target compression ratio of the subsequent block may include determining the target compression ratio of the subsequent block based on a difference between a target data size of a block group including the subsequent block and a data size of stored compression blocks in the block group.

The block group may be a column of macroblocks including the subsequent block.

The compressing of the blocks of the first frame may include compressing the first frame in units of a macroblock.

The compressing of the blocks of the first frame may include compressing the first frame by using a variable-length encoding method.

According to an aspect of another exemplary embodiment, there is provided a method of decoding image data, the method including: restoring a compressed and stored first frame of the image data, and decoding a second frame that is a current frame, with reference to the restored first frame; compressing blocks of the decoded second frame; determining whether each of the compressed blocks satisfies a corresponding target compression ratio; and selectively storing the compressed blocks based on the determination results.

According to an aspect of another exemplary embodiment, there is provided an apparatus for encoding image data, the apparatus including: a compression unit which compresses blocks of a first frame of the image data that is a reference frame; a control unit which controls the compressed blocks to be selectively stored based on whether each of the compressed blocks satisfies a corresponding target compression ratio; and a storage unit which selectively stores the compressed blocks under the control of the control unit.

According to an aspect of yet another exemplary embodiment, there is provided an apparatus for decoding image data, the apparatus including: a storage unit which stores a compressed first frame of the image data that is a reference frame; a decoding unit which restores the compressed first frame and which decodes a second frame that is a current frame, with reference to the restored first frame; a compression unit which compresses blocks of the decoded second frame; and a control unit which controls the compressed blocks to be selectively stored in the storage unit based on whether each of the compressed blocks satisfies a corresponding target compression ratio.

According to an aspect of still another exemplary embodiment, there is provided a method of processing image data, the method including: compressing and selectively storing blocks of a first frame of the image data; and processing a second frame by using the selectively stored compressed blocks of the first frame.

### BRIEF DESCRIPTION OF THE DRAWINGS

The above and other features and advantages will become more apparent by describing in detail exemplary embodiments thereof with reference to the attached drawings in which:

FIG. 1 is a block diagram of a data encoding apparatus according to an exemplary embodiment;

FIG. 2 is a block diagram of a data encoding apparatus according to another exemplary embodiment;

FIGS. 3A through 3D are diagrams for describing operations of a control unit of the data encoding apparatus illustrated in FIG. 1 or 2, according to exemplary embodiments;

FIG. 4 is a diagram for describing an operation of an encoding unit of the data encoding apparatus illustrated in FIG. 2, according to an exemplary embodiment;

FIG. 5 is a block diagram of a data decoding apparatus according to an exemplary embodiment;

FIG. 6 is a flowchart of a data encoding method according to an exemplary embodiment; and

FIG. 7 is a flowchart of a data decoding method according to an exemplary embodiment.

### DETAILED DESCRIPTION OF EXEMPLARY EMBODIMENTS

Hereinafter, certain exemplary embodiments will be described in detail with reference to the attached drawings.

FIG. 1 is a block diagram of a data encoding apparatus 100 according to an exemplary embodiment. Referring to FIG. 1, the data encoding apparatus 100 includes a compression unit 110, a control unit 120, and a storage unit 130. The data encoding apparatus 100 uses a first frame as a reference frame so as to encode a second frame.

The compression unit 110 compresses the first frame in units of a predetermined-sized block. The compression unit 110 may compress the first frame in units of various-sized blocks. For example, the compression unit 110 may compress the first frame in units of a 16×16 pixel-sized macroblock or may compress the first frame in units of a 32×32, 8×8, 4×4, or 1×16 pixel-sized block.

The compression unit 110 may compress one or more components of the first frame. For example, if the first frame is represented in a YUV format, the compression unit 110 may compress the Y, U, and/or V components of the first frame. Also, if the first frame is represented in an RGB format, the compression unit 110 may compress the R, G, and/or B components of the first frame.

The compression unit 110 compresses the first frame by using a lossless (or lossy) compression method. An example of the lossless compression method is a variable-length encoding method. The compression unit 110 may compress the first frame in units of a block or may compress the first frame in units of a sub-block included in the block. For example, the control unit 120 (to be described later) may determine whether to store the first frame in units of a 16×16 pixel-sized block and the compression unit 110 may compress the first frame in units of a 4×4 pixel-sized sub-block. In this case, a data size of a compressed block may be equal to the sum of data sizes of compressed sub-blocks.

The control unit 120 determines whether the compressed block satisfies a target compression ratio, and controls the storage unit 130 (to be described later) such that the compressed block is selectively stored according to the determination result. In more detail, the control unit 120 controls the storage unit 130 such that a block that satisfies a target compression ratio from among compressed blocks, compressed by the compression unit 110, is stored in a compressed state, and that a block that does not satisfy a target compression ratio is not stored. If the compression unit 110 performs compression in units of a sub-block, the control unit 120 may determine whether to store a block according to whether a data size of the block is equal to or less than the sum of data sizes of compressed sub-blocks.

In the following description, for convenience of explanation, a block that satisfies the target compression ratio is referred to as a compression block and a block that does not satisfy the target compression ratio is referred to as a skip block. The control unit 120 may determine target compression ratios of blocks to be the same, or may determine a target compression ratio of a subsequent block based on a compression ratio of at least one previous block.

Four exemplary methods of determining target compression ratios of blocks in the control unit 120 will now be described. However, it is understood that the target compression ratio determination methods are not limited thereto.

For convenience of explanation, it is assumed that, in the current exemplary embodiment, the first frame includes 256×256 pixels and is compressed in units of a 16×16 pixel-sized macroblock, and that one pixel is represented in 2 bytes. Also, it is assumed that an overall target compression ratio of the first frame is 2:1. Accordingly, a data size of the first frame before being compressed is 256×256×2 bytes (131072 bytes), and a target data size of the first frame after being compressed is 256×256×2/2 bytes (65536 bytes).

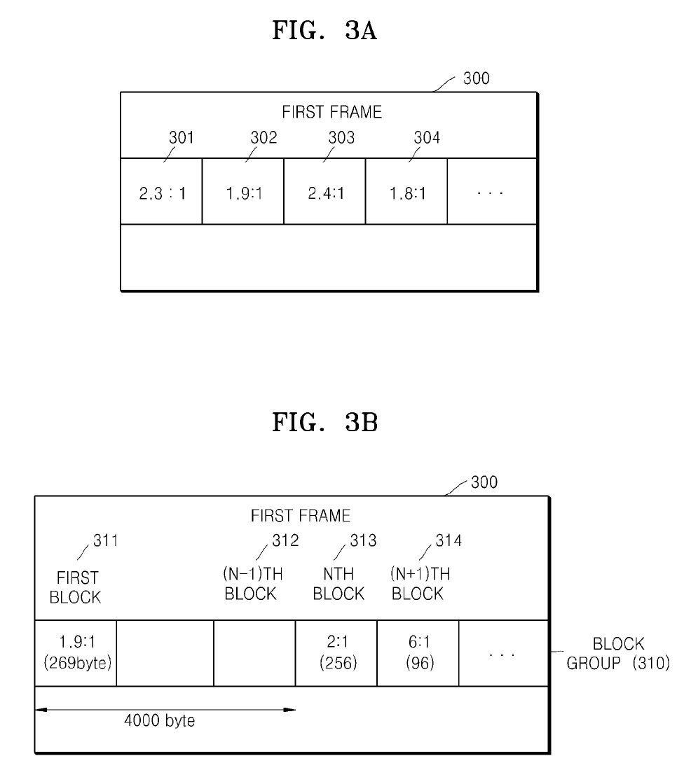

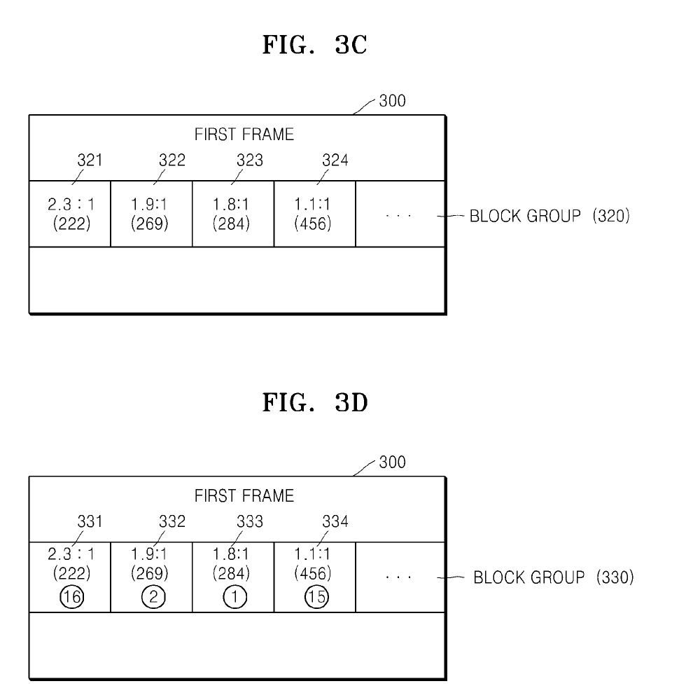

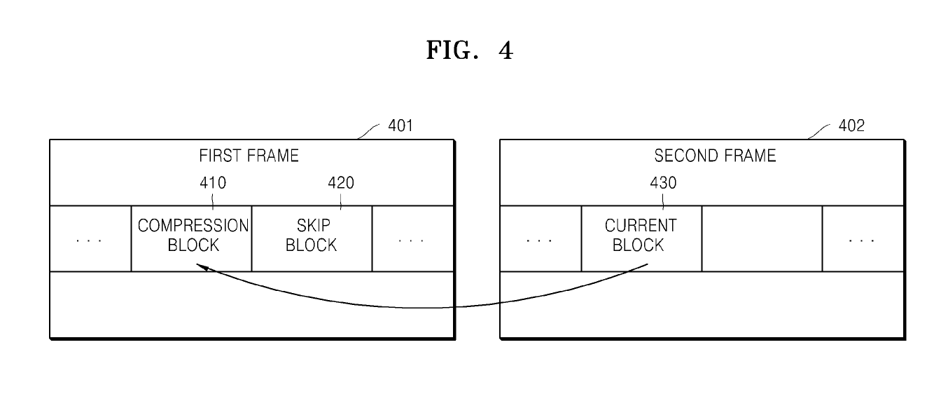

In a first exemplary method, the control unit 120 sets the same target compression ratio to all blocks. In this case, target compression ratios of the blocks are identically determined as 2:1 and target data sizes of the blocks are identically determined as 16×16×2/2 bytes (256 bytes). Accordingly, the control unit 120 determines whether a data size of each of the compressed blocks is equal to or less than 256 bytes, and controls the storage unit 130 not to store a block that is greater than 256 bytes. The first method will be described in greater detail later with reference to FIG. 3A.

In the first exemplary method, since compression ratios of previous blocks are not considered, operation of the control unit 120 is relatively simple. However, the first exemplary method is less efficient than a method of determining a target compression ratio of a subsequent block in consideration of compression ratios of previous blocks.

In a second exemplary method, the control unit 120 determines a target compression ratio of a subsequent block to be subsequently compressed, based on the difference between a target data size of a block group including the subsequent block and a data size of stored compression blocks in the block group.

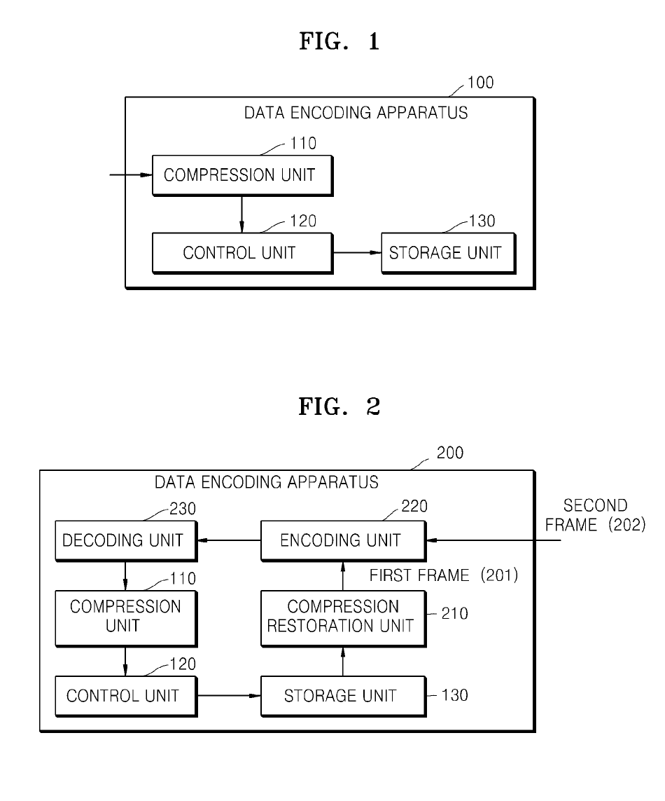

If blocks are grouped in units of a column of macroblocks, the first frame includes 16 block groups. Accordingly, a target data size of one block group is 256×16×2/2 bytes (4096 bytes). However, it is understood that an exemplary embodiment is not limited to a case where blocks are grouped in units of a column of macroblocks. For example, blocks may be grouped in units of a row of macroblocks or may be grouped in units of data prefetched for motion estimation to be performed by an encoding unit 220 (illustrated in FIG. 2). The second exemplary method will be described in greater detail later with reference to FIG. 3B.

In a third exemplary method, the control unit 120 allocates a target data size of a block group identically to blocks of the block group, and determines the sum of a data size allocated to a subsequent block and a data size that is not used in a previous block, as a target data size of the subsequent block. That is, the control unit 120 determines the target data size of the subsequent block based on a difference between a target data size allocated to first through subsequent blocks of the block group and a data size of stored compression blocks in the block group. The third exemplary method will be described in greater detail later with reference to FIG. 3C.

In a fourth exemplary method, the control unit 120 determines a target compression ratio of a subsequent block according to a priority of the subsequent block. For example, the compression unit 110 compresses blocks of a block group and stores the compressed blocks in a temporary storage such as a buffer. The control unit 120 may determine that a block to be probably referred to by the second frame from among blocks of the first frame has a high priority. Although it is uncertain before the second frame is encoded which one of the blocks of the first frame is referred to by the second frame, if a previous frame of the first frame, the first frame, and the second frame sequentially exist, blocks to be referred in different frames may have similar locations. Accordingly, priorities of the blocks of the first frame may be determined by analyzing which block of the previous frame is frequently referred to by the first frame. The control unit 120 determines target compression ratios of blocks included in a block group such that the blocks are stored in the order of their priorities. The fourth exemplary method will be described in greater detail later with reference to FIG. 3D.

The control unit 120 generates a skip flag representing a skip block that does not satisfy a target compression ratio and thus is not stored. When motion estimation is performed on the second frame, the encoding unit 220 (illustrated in FIG. 2) may determine whether the skip flag exists and may not refer to the skip block of the first frame accordingly.

In a related art encoding and/or decoding apparatus, a reference frame is stored without compressing the reference frame. Memory has to be accessed several times to encode and/or decode one image frame. Since the size of data to be transmitted at a time is large, power consumption is high and a bus requires a large bandwidth. In particular, if a bus having a limited bandwidth is used, a high-quality and large-sized frame, such as a full high-definition (HD) image frame, may not be encoded and/or decoded.

However, according to the current exemplary embodiment, the size of data to be transmitted to or read from memory may be reduced by compressing a reference frame before storing the reference frame. As such, power consumption of a bus may be reduced and large-sized and high-quality image data may be encoded and/or decoded by using a bus having a small bandwidth.

Also, according to the current exemplary embodiment, a frame may satisfy a target compression ratio by selectively storing compressed blocks. Also, when motion estimation is performed on a subsequent frame that refers to a stored frame, an error is prevented by not allowing a block of a reference frame that is not stored to be referenced. Accordingly, an image data decoding apparatus does not need to use a compression restoration unit to decode a frame without an error.

Also, according to the current exemplary embodiment, as a target compression ratio of a subsequent block is determined based on a compression ratio of a previous block, if a compression ratio of a certain region is high, although a compression ratio of other regions does not reach a target compression ratio, the region does not need to be skipped. Accordingly, even when compression is performed with a lossless method, the number of blocks not to be stored is greatly reduced.

FIG. 2 is a block diagram of a data encoding apparatus 200 according to another exemplary embodiment. Referring to FIG. 2, the data encoding apparatus 200 includes a compression unit 110, a control unit 120, a storage unit 130, a compression restoration unit 210, the encoding unit 220 and a decoding unit 230. In FIG. 2, the compression unit 110, the control unit 120, and the storage unit 130 operate similarly to those illustrated in FIG. 1 and, thus, detailed descriptions thereof will be omitted here.

The compression restoration unit 210 restores a compressed first frame 201. The encoding unit 220 encodes a second frame 202 based on the first frame 201. The decoding unit 230 decodes the encoded second frame 202. The data encoding apparatus 200 includes the decoding unit 230 in order to decode a subsequent frame with reference to a previous frame that is encoded and then is decoded.

Operation of the data encoding apparatus 200 will now be described according to time. For convenience of explanation, it is assumed that the first frame 201 is the first frame of image data and is an intra (I) frame.

The encoding unit 220 encodes the first frame 201. The encoded first frame 201 is transmitted to a decoding apparatus (not shown) through, for example, a communication line (not shown) and is also transmitted to the decoding unit 230. The decoding unit 230 decodes the encoded first frame 201.

The compression unit 110 compresses the first frame 201 that is encoded and then is decoded, in units of a predetermined-sized block. That is, the first frame 201 is divided in units of a predetermined-sized block and data of each predetermined-size block is compressed.

The control unit 120 determines whether the compressed block satisfies a target compression ratio, and controls the storage unit 130 such that the compressed block is selectively stored according to the determination result. In more detail, the control unit 120 controls the storage unit 130 such that a compression block that satisfies the target compression ratio is stored in the storage unit 130 in the compressed state and that a skip block that does not satisfy a target compression ratio is not stored. In this case, the control unit 120 may generate a skip flag representing a skip block with respect to each skip block. Compressed blocks are selectively stored in the storage unit 130 under the control of the control unit 120.

Then, the encoding unit 220 encodes the second frame 202, which is the second frame of the image data. It is assumed that motion estimation is performed on the second frame 202 with reference to the first frame 201. Specifically, the compression restoration unit 210 reads the compressed first frame 201 stored in the storage unit 130 and restores the first frame 201. The encoding unit 220 encodes the second frame 202 by using the restored first frame 201. The encoding unit 220 may perform motion estimation on the second frame 202. When motion estimation is performed on the second frame 202, the encoding unit 220 may prefetch data of a search region of the first frame 201 from the storage unit 130. Prefetching is an operation of continuously accessing memory and thus random access is not necessary. If the encoding unit 220 prefetches data, fixed coding does not need to be performed in units of a 16×16 or 8×8 block.

When motion estimation is performed on the second frame 202, the encoding unit 220 does not allow referring to skip blocks of the first frame 201. For example, the encoding unit 220 may not allow the second frame 202 to refer to a block having a skip flag in the first frame 201.

The completely encoded second frame 202 is transmitted to the decoding apparatus through the communication line and is also transmitted to the decoding unit 230. The decoding unit 230 decodes the second frame 202. Subsequently, like the first frame 201, the second frame 202 is compressed and is stored in the storage unit 130.

FIGS. 3A through 3D are diagrams for describing operations of the control unit 120 of the data encoding apparatus 100 or 200 illustrated in FIG. 1 or 2, according to exemplary embodiments. In FIGS. 3A through 3D, for convenience of explanation without limiting the exemplary embodiments, it is assumed that a first frame 300 includes 256×256 pixels and one pixel is represented in 2 bytes. Also, it is assumed that a target compression ratio of the first frame 300 is 2:1 and the first frame 300 is compressed in units of a 16×16 pixel-sized macroblock. Furthermore, it is assumed that the first frame 300 is divided into block groups in units of a column of macroblocks.

FIG. 3A shows an operation of the control unit 120, according to an exemplary embodiment. In FIG. 3A, regardless of compression ratios of previous blocks, target compression ratios of blocks are fixed as 2:1. A target data size of a block may be calculated according to Equation 1:

Target Data Size of Nth Block=Target Data Size of First Frame/Number of Blocks [Equation 1]

Based on Equation 1, the target data size of all blocks is 256 bytes. The control unit 120 determines whether a compressed block satisfies the target compression ratio. Referring to FIG. 3A, blocks 301 and 303 satisfy the target compression ratio and blocks 302 and 304 do not satisfy the target compression ratio. Accordingly, the control unit 120 controls the storage unit 130 to store the blocks 301 and 303 in a compressed state and to not store the blocks 302 and 304.

FIG. 3B shows an operation of the control unit 120, according to another exemplary embodiment. In FIG. 3B, a target compression ratio of a subsequent block to be subsequently compressed is determined based on a compression ratio of a previously compressed block. In particular, the target compression ratio of the subsequent block is determined based on a difference between a target data size of a block group including the subsequent block and a data size of stored compression blocks in the block group. A target data size of a block may be calculated according to Equation 2:

Target Data Size of Nth Block=Target Data Size of Block Group−Data Size of Compression Blocks Stored in Block Group [Equation 2]

According to Equation 2, a target data size of a first block 311 is 256×16×2/2 bytes (i.e., 4096 bytes). Referring to FIG. 3B, the first block 311 is compressed into 269 bytes and thus satisfies the target compression ratio. Accordingly, the control unit 120 controls the storage unit 130 to store the first block 311 in a compressed state.

According to Equation 2, a target data size of a second block (not shown) is 4096-269 bytes (i.e., 3827 bytes). It is assumed that the size of data obtained by compressing first through (n−1)th blocks 311 through 312 of the first frame 300 is 4000 bytes. According to Equation 2, a target data size of an nth block 313 is 4096-4000 bytes (i.e., 96 bytes). The nth block 313 is compressed into 256 bytes. Since the compressed nth block 313 does not satisfy the target compression ratio, the control unit 120 controls the storage unit 130 to not store the nth block 313.

Since the nth block 313 is not stored, a target data size of an (n+1)th block 314 is 96 bytes as in the nth block 313. The (n+1)th block 314 is compressed into 85 bytes. Since the compressed (n+1)th block 314 satisfies the target compression ratio, the control unit 120 controls the storage unit 130 to store the (n+1)th block 314.

FIG. 3C shows an operation of the control unit 120, according to another exemplary embodiment. In FIG. 3C, a target data size of a block group 320 is identically allocated to blocks of the block group 320, and a target data size of a subsequent block is determined based on a difference between a target data size allocated to first through subsequent blocks of the block group 320 and a data size of stored compression blocks in the block group 320. A target data size of a block may be calculated according to Equation 3:

Target Data Size of Nth Block=(Target Data Size of Block Group/Number of Blocks)×n−Data Size of Stored Compression Blocks [Equation 3]

According to Equation 3, a target data size of a first block 321 is 4096/16 bytes (i.e., 256 bytes). The first block 321 is compressed into 222 bytes. Since the first block 321 satisfies the target compression ratio, the control unit 120 controls the storage unit 130 to store the first block 321 in a compressed state.

According to Equation 3, a target data size of a second block 322 is (4096/16×2−222) bytes (i.e., 290 bytes). The second block 322 is compressed into 269 bytes. Since the second block 322 satisfies the target compression ratio, the control unit 120 controls the storage unit 130 to store the second block 322 in a compressed state.

According to Equation 3, a target data size of a third block 323 is (4096/16×3−491) bytes (i.e., 277 bytes). The third block 323 is compressed into 284 bytes. Since the third block 323 does not satisfy the target compression ratio, the control unit 120 controls the storage unit 130 to not store the third block 323.

According to Equation 3, a target data size of a fourth block 324 is (4096/16×4−491) bytes (i.e., 533 bytes). The target data size of the fourth block 324 is increased by the size of the third block 323 that is not stored. The fourth block 324 is compressed into 465 bytes. Since the fourth block 324 satisfies the target compression ratio, the control unit 120 controls the storage unit 130 to store the fourth block 324 in a compressed state.

FIG. 3D shows an operation of the control unit 120, according to another exemplary embodiment. In FIG. 3D, a target data size of a block may be calculated according to Equation 4:

Target Data Size of Block Having Nth Priority in Block Group=Target Data Size of Block Group-Size of Data Obtained by Compressing Blocks Having First through (N−1)th Priority in Block Group [Equation 4]

Hereinafter, for convenience of explanation, a target data size of a block group minus (−) the size of data obtained by compressing blocks having first through (n−1)th priorities in the block group is referred to as a remaining data size. In FIG. 3D, priorities of blocks included in a block group are compared and target compression ratios of the blocks are determined such that a block having a high priority is preferentially stored. Although priorities of blocks included in a block group are compared in FIG. 3D, according to another exemplary embodiment, priorities of blocks included in two or more block groups may be compared or priorities of all blocks included in a frame may be compared. Also, a target data size of a block group including a large number of blocks having high priorities may be determined to be large.

A method of determining priorities of blocks may be variously changed according to various exemplary embodiments. For example, a priority of a block to be frequently referred to by a subsequent frame may be determined to be high.

In FIG. 3D, a priority of a third block 333 is the highest. Accordingly, a target data size of the third block 333 is 4096 bytes. Referring to FIG. 3D, the third block 333 is compressed into 284 bytes. Since the third block 333 satisfies the target compression ratio, the control unit 120 controls the storage unit 130 to store the third block 333 in a compressed state.

In FIG. 3D, a priority of a second block 332 is the second highest. According to Equation 4, a target data size of the second block 332 is 4096-284 bytes (i.e., 3812 bytes). The second block 332 is compressed into 269 bytes. Since the compressed second block 332 satisfies the target compression ratio, the control unit 120 controls the storage unit 130 to store the second block 332.

It is assumed that all fourteen blocks having high priorities are compressed and stored, that only first and fourth blocks 331 and 334 having lowest priorities in the block group are left, and that a remaining data size of a block group 310 is 230 bytes.

The fourth block 334 has the fifteenth priority. According to Equation 4, a target data size of the fourth block 334 is 230 bytes. The fourth block 334 is compressed into 456 bytes. Since the compressed fourth block 334 does not satisfy the target compression ratio, the control unit 120 controls the storage unit 130 to not store the fourth block 334.

The first block 331 has the sixteenth priority. According to Equation 4, a target data size of the first block 331 is 230 bytes. The first block 331 is compressed into 222 bytes. Since the compressed first block 331 satisfies the target compression ratio, the control unit 120 controls the storage unit 130 to store the first block 331.

FIG. 4 is a diagram for describing operation of the encoding unit 220 of the data encoding apparatus 200 illustrated in FIG. 2, according to an exemplary embodiment. Referring to FIG. 4, a first frame 401 is compressed and stored in the storage unit 130, and is a reference frame to be referred to when motion estimation is performed on a second frame 402. A compression block 410 of the first frame 401 satisfies a target compression ratio and thus is stored in a compressed state, and a skip block 420 of the first frame 401 does not satisfy a target compression ratio and thus is not stored. That is, the encoding unit 220 may not obtain data of the skip block 420.

The encoding unit 220 performs motion estimation on a current block 430 of the second frame 402. The current block 430 detects the most similar block to the current block 430 from a search region of the first frame 401. If the most similar block to the current block 430 is the compression block 410, the encoding unit 220 generates a motion vector that represents a coordinate of the compression block 410. However, if the most similar block to the current block 430 is the skip block 420, the encoding unit 220 detects the second most similar block to the current block 430. As such, the encoding unit 220 detects the most similar block to the current block 430 from among compression blocks, and generates a motion vector that represents a coordinate of the detected block. The encoding unit 220 may check a skip flag to determine whether the detected block is a skip block or a compression block.

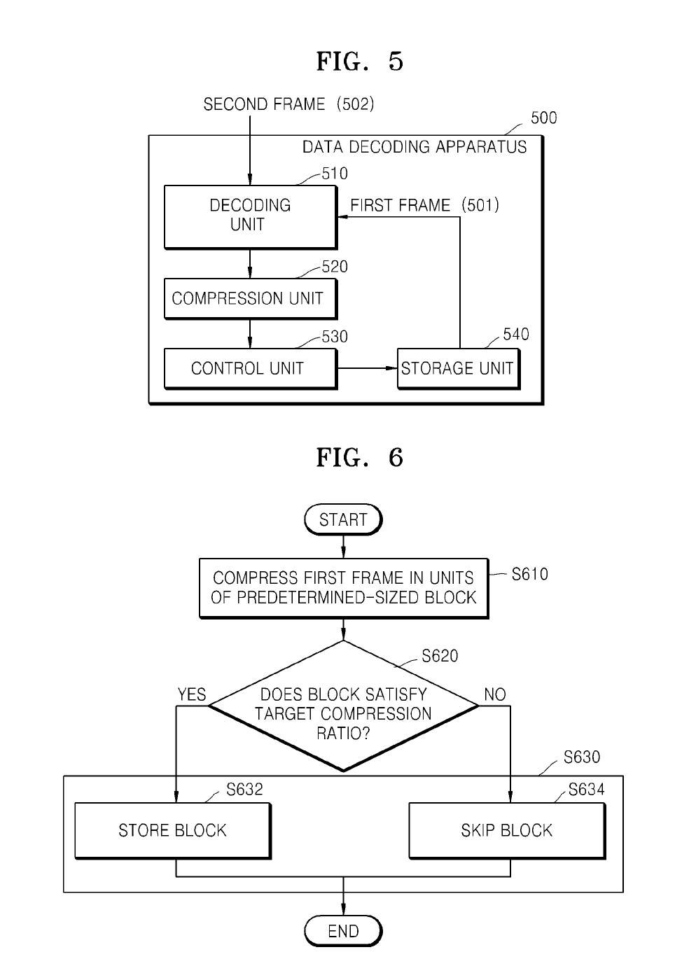

FIG. 5 is a block diagram of a data decoding apparatus 500 according to an exemplary embodiment. Referring to FIG. 5, a first frame 501, which is a reference frame, is stored in a compressed state in a storage unit 540 to be described later, and a second frame 502 to be subsequently decoded is decoded with reference to the first frame 501.

A decoding unit 510 restores the compressed first frame 501, and decodes the second frame 502 by using the restored first frame 501. The decoding unit 510 may include a compression restoration unit (not shown).

A compression unit 520 compresses the decoded second frame 502 in units of a predetermined-sized block. For example, the second frame 502 may be compressed in units of a 16×16 pixel-sized macroblock. The compression unit 520 may use any compression method and may simultaneously use one or more compression methods. An example of a compression method used by the compression unit 520 is a variable-length encoding method.

A control unit 530 determines whether each compressed block satisfies a target compression ratio and controls the storage unit 540 such that the compressed block is selectively stored based on the determination result. That is, the control unit 530 controls the storage unit 540 such that only compression blocks that satisfy target compression ratios from among the compressed blocks are stored. According to exemplary embodiments, various methods of determining a target compression ratio may be used. For example, regardless of compression ratios of previous blocks, target compression ratios of blocks may be determined to be the same. However, alternatively, a compression ratio of a subsequent block may be determined in consideration of compression ratios of previous blocks, as described above with reference to FIGS. 3B-3D.

As a non-limiting example of the latter, a target compression ratio of a subsequent block may be determined based on a difference between a target data size of a block group including the subsequent block and a size of data used to compress and store previous blocks of the block group. Alternatively, a target data size of a block group is allocated to blocks of the block group and a target compression ratio of a subsequent block may be determined based on a difference between a target data size allocated to first through subsequent blocks of the block group and a data size of stored compression blocks in the block group.

The storage unit 540 stores compressed blocks under the control of the control unit 530.

FIG. 6 is a flowchart of a data encoding method according to an exemplary embodiment. Referring to FIG. 6, in operation S610, a first frame, i.e., a reference frame, is compressed in units of a predetermined-sized block. A second frame to be subsequently encoded refers to the first frame.

In operation S620, it is determined whether each compressed block of the first frame satisfies a target compression ratio.

In operation S630, the compressed block is selectively stored based on the determination result. In more detail, if the compressed block satisfies the target compression ratio, the compressed block is stored in operation S632. If the compressed block does not satisfy the target compression ratio, the compressed block is not stored and is skipped in operation S634.

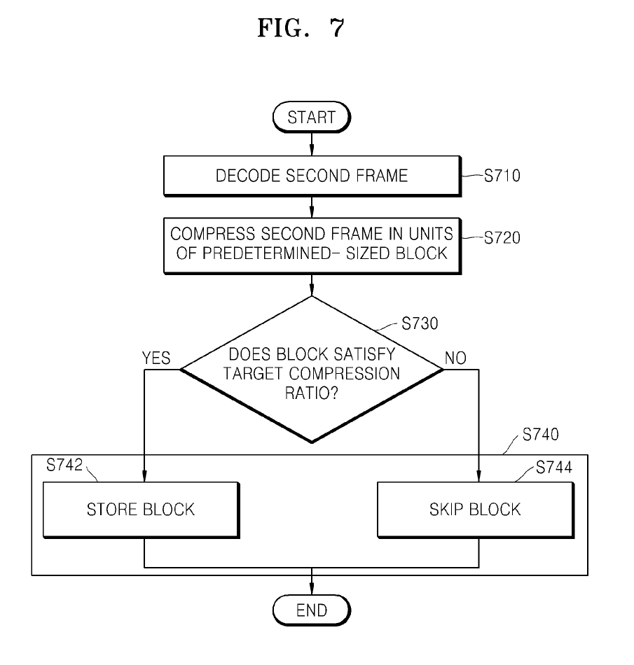

FIG. 7 is a flowchart of a data decoding method according to an exemplary embodiment. Referring to FIG. 7, a first frame to be referred to by a second frame to be subsequently decoded is previously decoded and is stored in a compressed state.

In operation S710, the compressed first frame is restored and the second frame is decoded by using the restored first frame.

In operation S720, the decoded second frame is compressed in units of a predetermined-sized block.

In operation S730, it is determined whether each compressed block of the decoded second frame satisfies a target compression ratio.

In operation S740, the compressed block is selectively stored based on the determination result. In more detail, if the compressed block satisfies the target compression ratio, the compressed block is stored in operation S742. If the compressed block does not satisfy the target compression ratio, the compressed block is not stored and is skipped in operation S744.

The exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc. Also, the exemplary embodiments may be written as computer programs transmitted over a computer-readable transmission medium, such as a carrier wave, and received and implemented in general-use digital computers that execute the programs. Moreover, while not required in all aspects, one or more units of the data encoding apparatus 100 or 200 and/or the data decoding apparatus 500 can include a processor or microprocessor executing a computer program stored in a computer-readable medium, such as the storage unit 130 or 540.

While the present invention has been particularly shown and described with reference to exemplary embodiments thereof, it will be understood by one of ordinary skill in the art that various changes in form and details may be made therein without departing from the spirit and scope of the invention as defined by the following claims. The exemplary embodiments should be considered in a descriptive sense only and not for purposes of limitation. Therefore, the scope of the invention is defined not by the detailed description of the invention but by the following claims, and all differences within the scope will be construed as being included in the present invention.

What is claimed is:

1. A method of encoding image data, the method comprising:
compressing blocks of a first frame of the image data that is a reference frame;
determining whether each of the compressed blocks of the first frame satisfies a corresponding target compression ratio; and
selectively storing each of the compressed blocks of the first frame based on the corresponding determination result for the respective compressed block.

2. The method of claim 1, wherein the selectively storing of each of the compressed blocks comprises:
if the compressed block is a compression block that satisfies the corresponding target compression ratio, storing the compressed block; and
if the compressed block is a skip block that does not satisfy the corresponding target compression ratio, not storing the compressed block.

3. The method of claim 2, wherein the not storing of the compressed block comprises generating a skip flag representing that the compressed block is the skip block.

4. The method of claim 3, further comprising performing a motion estimation on a second frame subsequent to the first frame by using the selectively stored compressed blocks of the first frame and not referring to the skip blocks according to the generated skip flags.

5. The method of claim 2, further comprising performing a motion estimation on a second frame subsequent to the first frame by using the selectively stored compressed blocks of the first frame, and not referring to the skip blocks.

6. The method of claim 2, wherein the determining of whether each of the compressed blocks satisfies the corresponding target compression ratio comprises determining a corresponding target compression ratio of a subsequent block to be subsequently compressed, based on a compression ratio of at least one previous block.

7. The method of claim 2, wherein the determining of whether each of the compressed blocks satisfies the corresponding target compression ratio comprises determining a corresponding target compression ratio of a subsequent block to be subsequently compressed, based on a priority of the subsequent block.

8. The method of claim 6, wherein the determining of the corresponding target compression ratio of the subsequent block comprises determining the corresponding target compression ratio of the subsequent block based on a difference between a target data size of a block group including the subsequent block and a data size of stored compression blocks in the block group.

9. The method of claim 7, wherein the block group is a column of macroblocks including the subsequent block.

10. The method of claim 1, wherein the compressing of the blocks of the first frame comprises compressing each of the blocks of the first frame in units of a sub-block.

11. The method of claim 1, wherein the compressing of the blocks of the first frame comprises compressing the first frame in units of a macroblock.

12. The method of claim 1, wherein the compressing of the blocks of the first frame comprises compressing the first frame by using a variable-length encoding method.

13. A method of decoding image data, the method comprising:
restoring a compressed and stored first frame of the image data, and decoding a second frame that is a current frame of the image data, with reference to the restored first frame;
compressing blocks of the decoded second frame;
determining whether each of the compressed blocks of the decoded second frame satisfies a corresponding target compression ratio; and
selectively storing each of the compressed blocks of the decoded second frame based on the corresponding determination result for the respective compressed block.

14. The method of claim 13, wherein the selectively storing of the compressed blocks comprises:
if the compressed block is a compression block that satisfies the corresponding target compression ratio, storing the compressed block; and
if the compressed block is a skip block that does not satisfy the corresponding target compression ratio, not storing the compressed block.

15. The method of claim 14, wherein the not storing of the compressed block comprises generating a skip flag representing that the compressed block is the skip block.

16. The method of claim 13, wherein the determining of whether each of the compressed blocks satisfies the corresponding target compression ratio comprises determining a corresponding target compression ratio of a subsequent block to be subsequently compressed, based on a compression ratio of at least one previous block.

17. The method of claim 13, wherein the determining of whether each of the compressed blocks satisfies the corresponding target compression ratio comprises determining a corresponding target compression ratio of a subsequent block to be subsequently compressed, based on a priority of the subsequent block.

18. The method of claim 16, wherein the determining of corresponding the target compression ratio of the subsequent block comprises determining the corresponding target compression ratio of the subsequent block based on a difference between a target data size of a block group including the subsequent block and a data size of stored compression blocks in the block group.

19. The method of claim 18, wherein the block group is a column of macroblocks including the subsequent block.

20. The method of claim 13, wherein the compressing of the blocks of the second frame comprises compressing each of the blocks of the second frame in units of a sub-block.

21. The method of claim 13, wherein the compressing of the blocks of the second frame comprises compressing the second frame in units of a macroblock.

22. The method of claim 13, wherein the compressing of the blocks of the second frame comprises compressing the second frame by using a variable-length encoding method.

23. An apparatus for encoding image data, the apparatus comprising:
a compression unit which compresses blocks of a first frame of the image data that is a reference frame;
a control unit which controls each of the compressed blocks of the first frame to be selectively stored based on whether each of the compressed blocks satisfies a corresponding target compression ratio for the respective compressed block; and
a storage unit which selectively stores each of the compressed blocks under the control of the control unit.

24. An apparatus for decoding image data, the apparatus comprising:
a storage unit which stores a compressed first frame of the image data that is a reference frame;
a decoding unit which restores the compressed first frame and which decodes a second frame of the image data that is a current frame, with reference to the restored first frame;
a compression unit which compresses blocks of the decoded second frame; and
a control unit which controls each of the compressed blocks of the decoded second frame to be selectively stored in the storage unit based on whether each of the compressed blocks of the decoded second frame satisfies a corresponding target compression ratio for the respective compressed block.

25. A computer readable recording medium having recorded thereon a computer program for executing the method of claim 1.

26. A computer readable recording medium having recorded thereon a computer program for executing the method of claim 13.

27. A method of processing image data, the method comprising:
compressing and selectively storing blocks of a first frame of the image data; and
processing a second frame by using the selectively stored compressed blocks of the first frame.

28. The method of claim 27, wherein the processing of the second frame comprises performing a motion estimation on the second frame by using the selectively stored compressed blocks of the first frame.

29. A computer readable recording medium having recorded thereon a computer program for executing the method of claim 27.
